(19) United States
(12) Patent Application Publication
(10) Pub. No.: US 2017/0190286 A1
(43) Pub. Date: Jul. 6, 2017

(54) GPS Vehicle Speed and Velocity Change Indicator

(71) Applicant: Edward Yavitz, Loves Park, IL (US)

(72) Inventor: Edward Yavitz, Loves Park, IL (US)

(21) Appl. No.: 14/986,708

(22) Filed: Jan. 3, 2016

(51) Int. Cl. B60Q 1/54; B60Q 1/26; G01S 19/52; B60Q 1/50

(52) U.S. Cl. CPC B60Q 1/54; B60Q 1/503; B60Q 1/2665; G01S 19/52; B60Q 2400/50

(57) ABSTRACT

A technique to improve traffic flow by indicating the actual speed and any change in acceleration of a lead vehicle to a following driver. The technique utilizes a GPS sensor coupled to a display configured to be mounted or projected on the rear window of a lead vehicle. The speed is displayed in red if the vehicle is decelerating and green if the vehicle is accelerating. It blinks white if the speed is constant. The display is also readable to the driver of the lead vehicle when viewed through the rear view mirror of the lead car.

### FIELD OF THE INVENTION

The present invention relates generally to the improvement of traffic flow, and more particularly, to indicating to drivers the instantaneous actual speed and any change in acceleration of the vehicle in front of them.

### BACKGROUND OF THE INVENTION

Traffic flow is important to the economy and prosperity of any major metropolitan area. Highways are designed to allow vehicles to freely travel virtually anywhere at anytime. However, cities in America are increasingly seeing shortages of highway capacity due to increased numbers of vehicles. These shortages are costing vehicle drivers both health and money. Traffic congestion costs taxpayers over $100 billion a year in excess fuel costs and has been linked to high blood pressure, sleep deprivation, and depression. The average American wastes over a full workweek sitting in traffic each year.

Modern highways could have greatly increased efficiency of flow if, for example, vehicles could maintain movement with less than a car length between each vehicle for measurable lengths of time. In reality, however, a given density of cars can be traveling at 30 to 40 mph and then slow to a complete stop during rush hour traffic conditions. The reason for this anomaly is that humans cannot determine changes in the rate of acceleration of objects. When a lead vehicle in a line of traffic slows for any reason, the following vehicle's driver only has two cues: The onset of brake lights of the lead vehicle and the fact that its relative size is increasing, indicating that it is coming closer. The following vehicle's driver tends to overcompensate to ensure a minimum distance from the lead vehicle to avoid an accident. The vehicle behind the following vehicle then does likewise resulting in a chain of vehicles each of which is decelerating more than the vehicle in front of it. Ultimately, the line of traffic stops because of a miscalculation of the actual speed and the rate of deceleration of the vehicles in front of each motorist. Similarly, it takes longer than necessary to resume travel at maximum speed.

With heavier traffic, the scenario is common. Slight obstructions can cause extreme reductions in traffic flow. Traffic expands and contracts in slinky-like fashion around the area of such an obstruction even hours after the obstruction is cleared and for miles from the actual site of the obstruction, wasting gas, fraying nerves and causing accidents and further delays.

The continued congestion long after an obstruction is cleared has been referred to as an invisible traffic jam. The phenomenon is caused by drivers' inability to accurately estimate the deceleration and acceleration rates of cars in front of them. This inability causes overcompensation when a lead vehicle applies its brakes resulting in a sequence of progressively slower moving cars until traffic comes to a complete halt.

Eaton Corporation has patented a deceleration warning system for trucks which involves using a radar sensor on the front of the truck which sets off an alarm when the closing rate of the truck upon the vehicle ahead becomes dangerous. However, radar is expensive and does not work in situations where the vehicle ahead is not directly aligned with the truck or car so equipped. For example, curves or even fixed metal objects on the side of the road pose problems for radar. Other possible signaling devices have the same inherent flaws as radar systems when it comes to curves in the road or stray signals from vehicles ahead but in a different lane.

### SUMMARY OF THE INVENTION

The present invention relates generally to a technique for calculating the speed of a vehicle using a GPS device, then displaying the speed and acceleration of the vehicle to an observer behind the vehicle and, in some embodiments, to the driver of the vehicle. In a preferred embodiment, a method is provided for preventing traffic jams, the method comprising displaying a vehicle's speed and acceleration to a following driver. A rear windshield mounted digital display indicates the actual speed of the vehicle to following drivers as well as the direction of any change in acceleration. The speed may be displayed in white if acceleration is constant, red if the vehicle is decelerating and green if the vehicle is accelerating. A numerical display is readable to the driver of the vehicle if the display is mounted in the rear window and when viewed by the driver through the rear view mirror. Another embodiment of the present invention comprises displaying the speed of a vehicle to a following vehicle, wherein the following vehicle uses an apparatus for sensing the speed displayed by the lead vehicle and linking the speed sensing device with a speed controller in a following vehicle so the speed controller automatically adjusts the speed of the following vehicle based upon the displayed speed of the lead vehicle.

### BRIEF DESCRIPTION OF THE DRAWINGS

The invention will hereafter be described with reference to the accompanying drawings wherein like reference numerals denote like elements, and:

FIG. 1 is a side view of vehicles in a typical traffic situation;

FIG. 2 is a side view of vehicles in a typical traffic situation, the lead vehicle having a rear speed indicator;

FIG. 3 is a diagram of the electrical or mechanical connections of the rear speed indicator;

FIG. 4 is a rear view of a vehicle having a rear speed indicator;

FIG. 5 is a rear view of a vehicle having an alternate embodiment indicator comprising a heads-up display rear speed indicator;

FIG. 6 is a side view illustrating the orientation of the rear speed indicator with respect to the first and second drivers;

FIG. 7 is a side view of vehicles in traffic, the following vehicle having another embodiment of the present invention for sensing and displaying the speed of the lead vehicle within the following vehicle;

FIG. 8 is a view from inside the following vehicle showing another alternate embodiment of the invention where the rear speed indicator of the lead vehicle is sensed by the following vehicle and displayed within the following vehicle in heads-up format on the front windshield; and

FIG. 9 is a diagram of an alternate embodiment of the invention utilizing an automated control system.

### DETAILED DESCRIPTION OF EXEMPLARY EMBODIMENTS

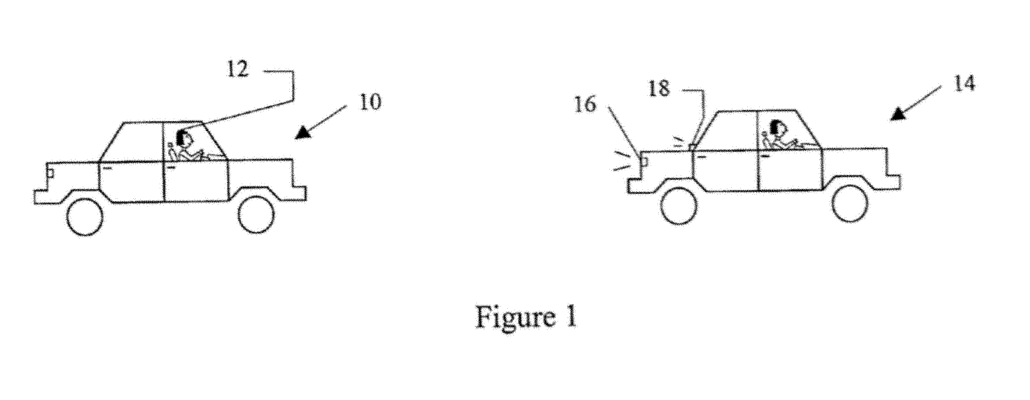

Referring generally to FIG. 1, a typical traffic situation is illustrated. A following vehicle 10, driven by a driver 12, is shown following a lead vehicle 14. The driver 12 may be referred to as the following driver. As is common in traffic situations, the lead vehicle 14 is decelerating for any of various reasons including debris in the road, a traffic accident ahead, or a slowing vehicle in front of the lead vehicle 14. In assessing the deceleration of the lead vehicle 14, the following driver 12 commonly has difficulty estimating the exact speed of the lead vehicle 14 and has difficulty determining the amount of deceleration needed for the following vehicle 10 to avoid getting any closer to the lead vehicle 14. Also, the following driver's 12 situation is worsened by following the lead vehicle 14 too closely, which allows little reaction time.

The difficulty with estimating the lead vehicle's 14 deceleration rate and the short reaction time generally result in overcompensation by the following driver 12. Brake lights 16 help prevent accidents by indicating to the following driver 12 that the lead vehicle 14 is decelerating. However, brake lights 16 do not indicate the rate of the lead vehicle's 14 deceleration. The newer generation of elevated brake lights 18 mounted in the rear window of most vehicles are more visible than the older brake lights 16; however, they do not help the following driver 12 estimate the rate of deceleration of the lead vehicle 14.

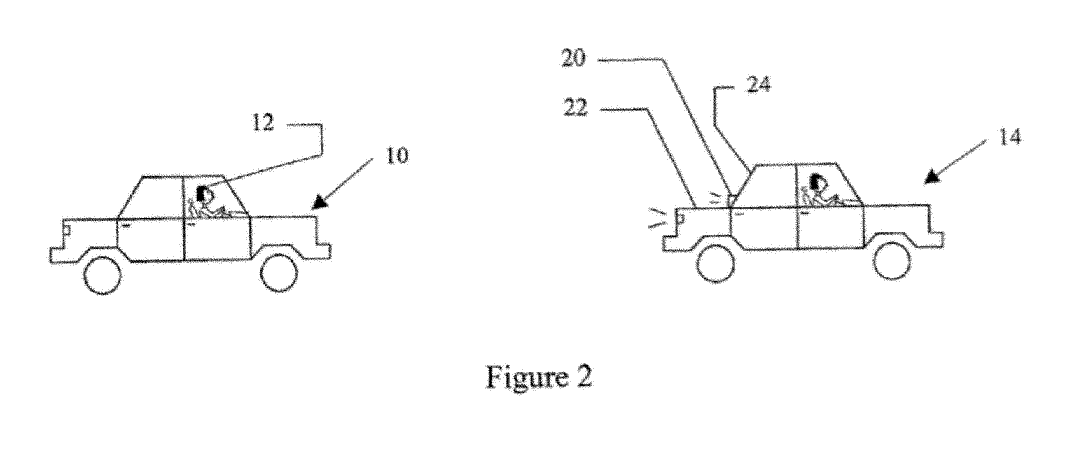

An exemplary embodiment of the present invention provides a method to warn the following driver 12 who needs to estimate the rate of deceleration of the lead vehicle 14. With reference to FIG. 2, the exemplary embodiment is illustrated on the lead vehicle 14. The lead vehicle 14 has a rear speed indicator 20. The rear speed indicator 20 is mounted proximate the trunk 22, for instance, and extends upward covering a portion of the rear windshield 24. In the exemplary embodiment, the rear speed indicator 20 displays the speed of the lead vehicle 14 in alphanumeric format to the following driver 12. The display also indicates the direction of any change in acceleration. The speed, if held constant, is displayed in blinking white, in red if the vehicle is decelerating and green if the vehicle is accelerating. The following driver 12 is able to see the speed and change in velocity, if any, of the lead vehicle 14 as indicated on the rear speed indicator 20 and to adjust the speed of the following vehicle 10 accordingly.

The rear speed indicator 20 displays the speed of the lead vehicle 14 in alphanumeric format. However, a graphical format, or other formats that convey the actual numerical speed or the speed relative to a predetermined value may be used. The rear speed indicator 20 may comprise an analog gauge, a digital display, a series of lights, or any other display or indicator that shows an actual speed.

The rear speed indicator 20 may also comprise a digital transparent display such that it is visible both to the following driver 12 and to a driver of the lead vehicle. The driver of the lead vehicle is able to view the display mounted or projected on the rear window by viewing it through the rear view mirror. This aspect will be discussed in more detail below.

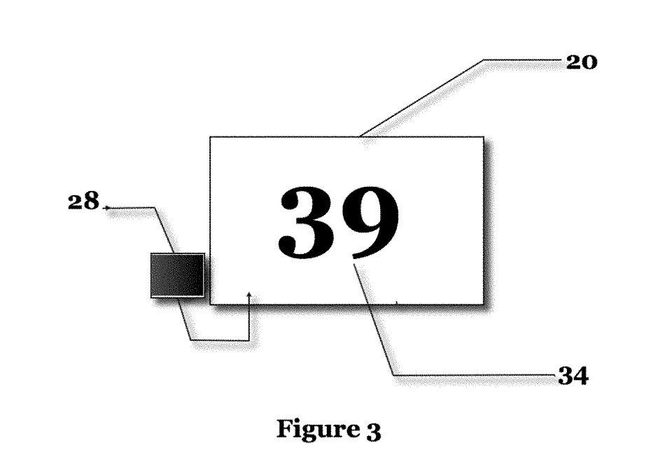

Referring to FIG. 3, the rear speed indicator 20 uses its own dedicated GPS sensor 28. The GPS sensor 28 is electrically or mechanically coupled to the indicator display 20, which may comprise an analog gauge, a digital display, or a heads-up projection display. The components and operation of the GPS 28 are well known to a person having ordinary skill in the art as is its ability to calculate instantaneous speed as a function of the change in the location of the vehicle over time. The GPS also calculates any change in acceleration of the vehicle without requiring an accelerometer by registering an increase or decrease in speed over time.

The speed and acceleration indicator 20 may be electrically or mechanically coupled to the GPS sensor 28 as illustrated in FIG. 3. The rear speed indicator 20 converts the electrical or mechanical signal from the speed sensor 28 into a readout display 34 as shown on the rear speed indicator 20. This may be accomplished according to a variety of techniques known to those of ordinary skill in the art.

Display 34 warns the following driver 12 to adjust the speed of the following vehicle 10 without overcompensating. The effects of overcompensation, then, are not passed from vehicle to vehicle in dense traffic situations that would otherwise ultimately result in a slinky type traffic jam whereby a line of vehicles is quick to come to a complete stop and slow to expand to normal flow. The speed and velocity change indicator 20 helps alleviate traffic jams, which constitute a substantial portion of time and energy waste in major urban areas.

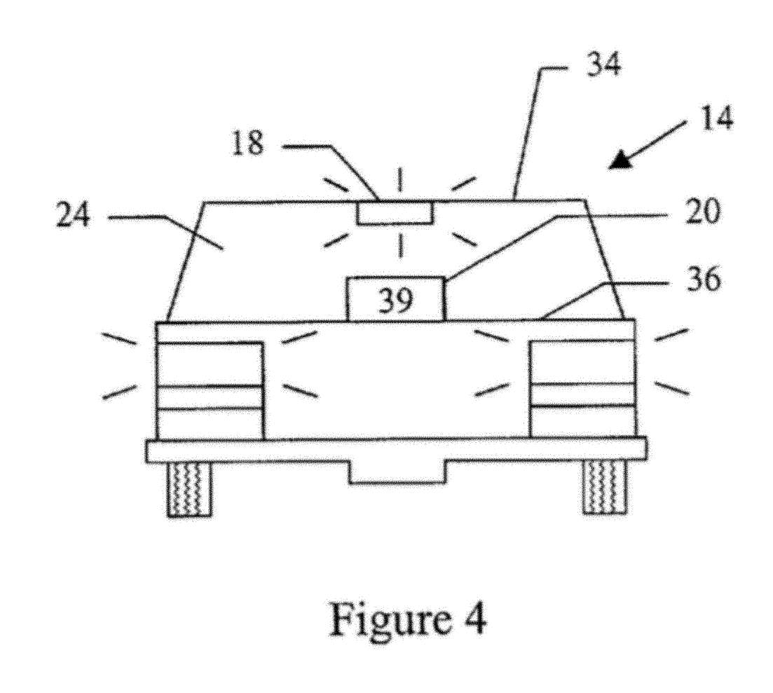

As illustrated in FIG. 4, the rear speed indicator 20 may replace the elevated brake light 18, or it may be combined with the elevated brake light 18. The elevated brake light 18 may be moved to the top 34 of the rear windshield 24 to allow the rear speed indicator 20 to be located at the bottom 36 of the rear windshield 24. Alternatively, the brake light 18 may remain at the bottom 36, and the rear speed indicator 20 may be located at the top 34. However, the invention is not limited to these arrangements. The rear speed indicator 20 may be placed on the trunk 22 (see FIG. 2), on the rear portion of the lead vehicle 14, or anywhere on the lead vehicle 14 such that it can be seen by the following driver 12 (see FIG. 2).

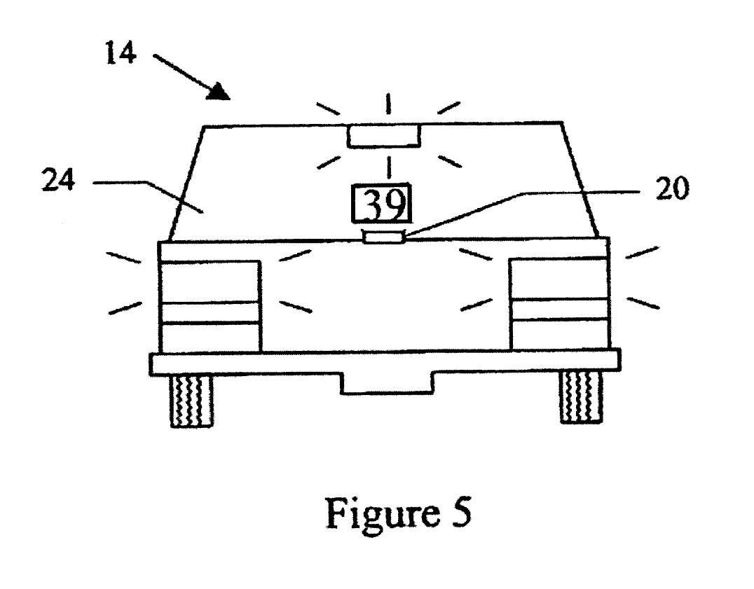

As shown in FIG. 5, the rear speed indicator 20 may take the form of a “heads-up” display. Heads-up displays are commonly used in vehicles to indicate speed or other parameters on the front windshield such that they are viewable by a driver. The rear speed indicator 20 may comprise a heads-up display projected on the rear windshield 24 such that the speed of the lead vehicle 14 is displayed on the rear windshield 24 of the lead vehicle 14. When the rear speed indicator 20 utilizes this embodiment, the following driver 12 (see FIG. 2) is able to see the speed of the lead vehicle 14 displayed in the rear windshield 24.

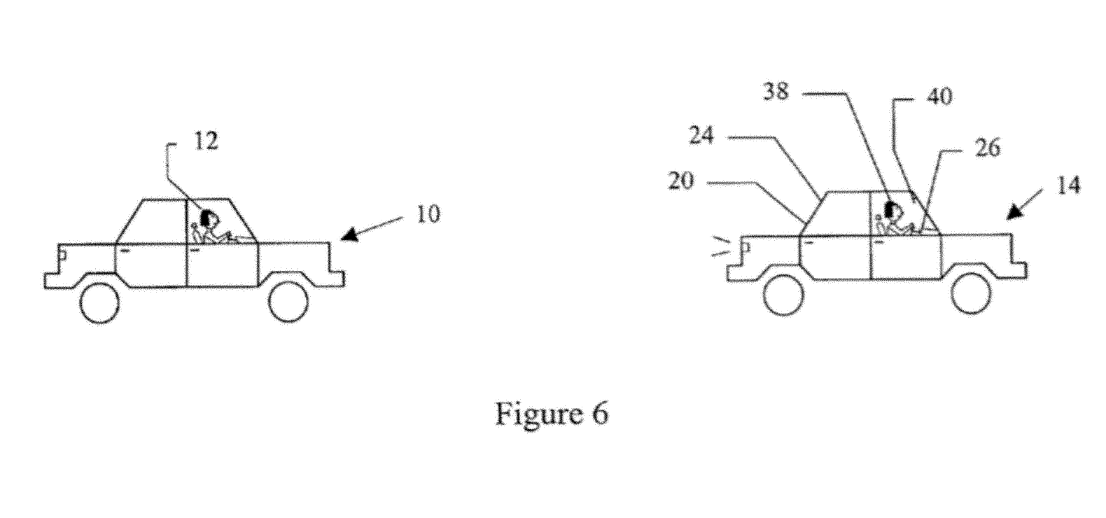

With reference to FIG. 6, when the lead driver 38 looks in the rear-view mirror 40, the lead driver 38 has an unobstructed view through the rear windshield 24 while receiving an indication of the speed of his or her own vehicle by visualizing the speed and velocity change display 20 without looking down at the speedometer on the dashboard 26. When the speed is displayed in the rear windshield 24 in the proper form for viewing by the following driver 12, the rear-view mirror provides a mirror image for the lead driver 38. This arrangement allows the lead driver 38 to see his speed in its proper orientation by simply looking at the rear-view mirror 40 without taking his eyes off the road, since the road is usually in view as a driver looks into the rear view mirror 40 but not when the driver looks down to the dashboard 26.

The technique is not limited to speed. Other information may be displayed using the technique, such as fuel remaining, low fuel warning, odometer or trip meter, or a variety of other measurements or warnings. The information can be displayed on the rear windshield 24 in the same manner as the speed such that when viewed through the rear view mirror 40, it is properly oriented for viewing by the lead driver 38.

The rear speed and velocity change indicator 20 does not have to take the form of a heads-up display to be viewed by the lead driver 38 through the rear view mirror 40. Other types of transparent display would allow the speed or other information to be seen both by the lead driver 38 and by the following driver 12. The information is properly oriented for viewing by the lead driver 38 when reflected through the rear view mirror 40.

Display in this manner allows the lead driver 38 to keep his eyes on the road while monitoring automobile parameters. The lead driver 38 does not have to look down at the gauges and indicators in the dash 26. Even more importantly, a warning indicator displayed such that it can be viewed through the rear view mirror 40 is more likely to catch the lead driver's 38 attention.

Because the purpose of this device is to warn following drivers of the speed and acceleration of lead vehicles during high traffic, low velocity conditions such as rush hour, the speed is not displayed in the rear speed indicator 20 until the lead vehicle 14 is traveling below some predetermined speed or until the brakes are applied in the lead vehicle 14. In the latter situation, the rear speed indicator 20 displays the speed and change in acceleration when the brake lights 16, 18 are illuminated. Drivers who “ride their brakes” without actually decelerating will not cause following vehicles to slow unnecessarily when their drivers see a speed and velocity display that remains numerically constant and white in color. Also, when drivers coast/decelerate without touching their brakes, this invention still warns following drivers.

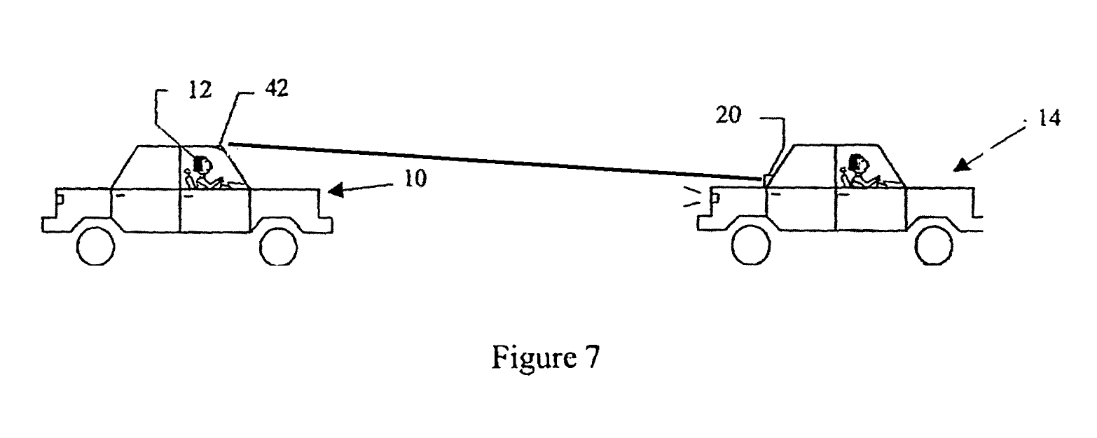

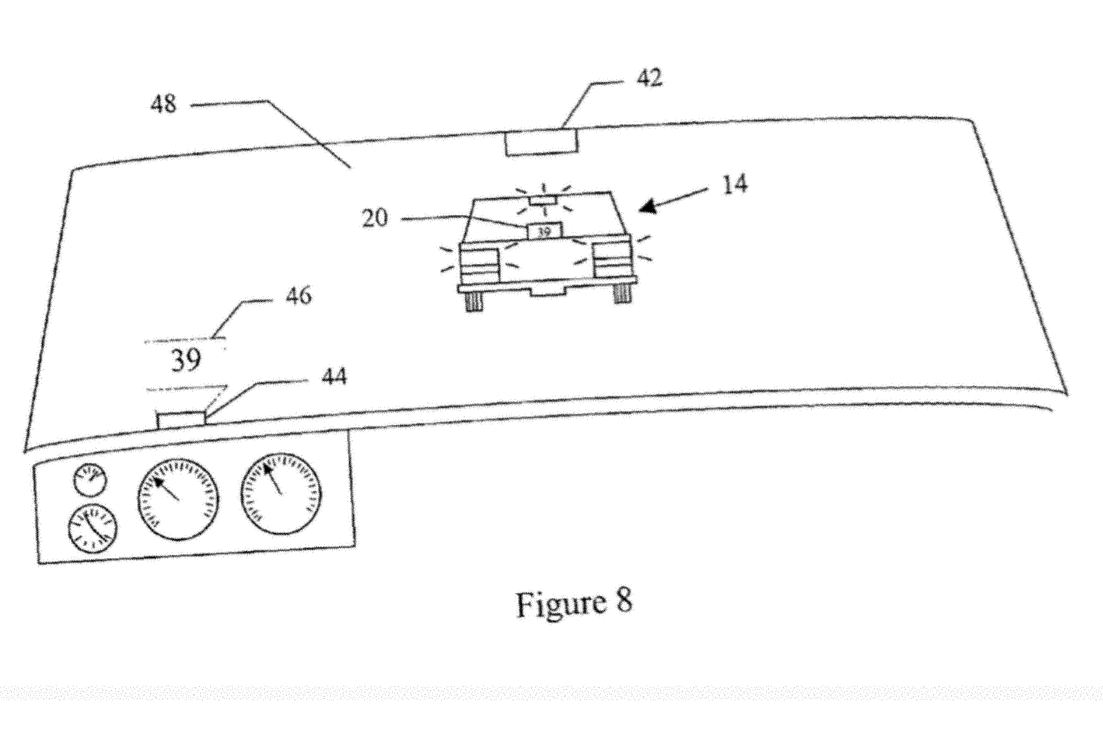

With reference to FIGS. 7 and 8, another alternate embodiment of the present invention replaces the requirement that the following driver 12 see the rear speed indicator 20 on the lead vehicle 14. A sensing apparatus 42 is mounted on the following vehicle 10 for sensing the speed shown on the rear speed indicator 20 located on the lead vehicle 14. The sensing apparatus 42 transmits the speed to a display apparatus 44 within the following vehicle 10 (see FIG. 8). As shown in FIG. 8, the display apparatus 44 may be a gauge type display, a digital display, or a heads-up display 46 projected on the front windshield 48 of the following vehicle 10.

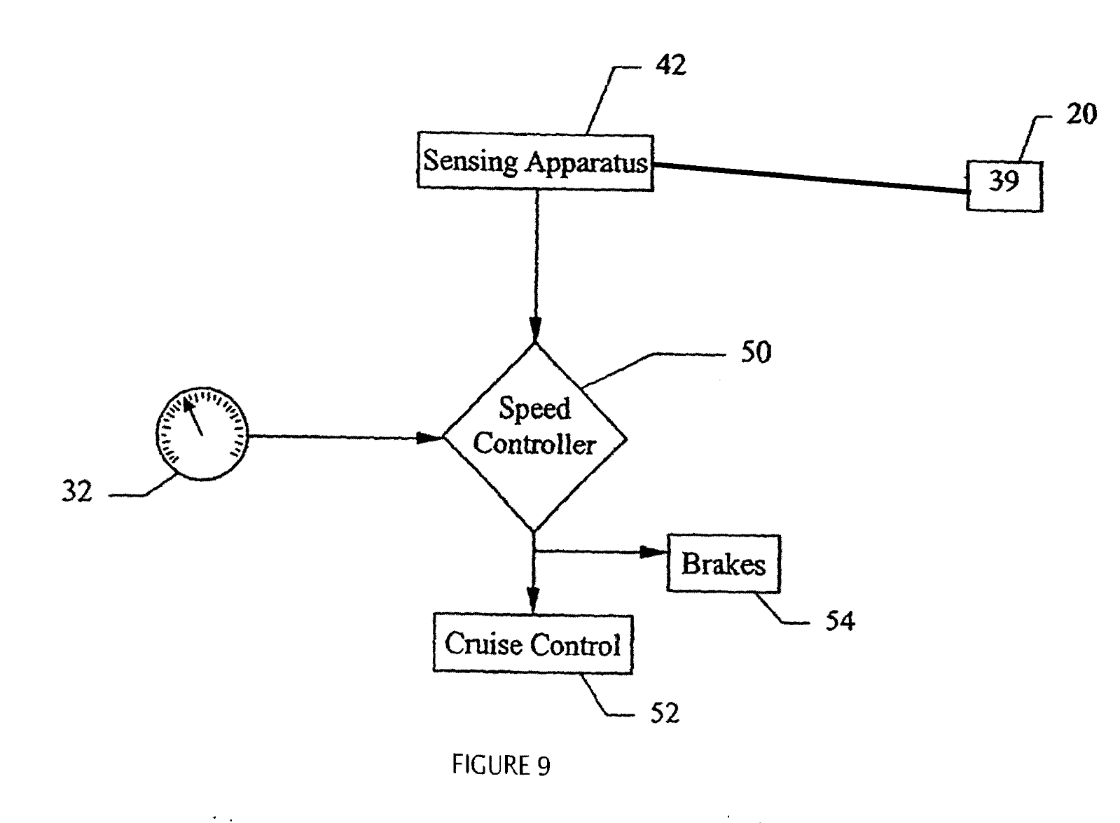

With reference to FIG. 9, a further alternate embodiment of the present invention comprises linking the sensing apparatus 42 to a speed controller 50. The speed controller 50 may obtain the speed of the following vehicle 10 from the speedometer 32 of the following vehicle 10. Alternatively, the speed controller 50 may obtain the speed of the following vehicle 10 from a GPS speed sensor 28 as described above with reference to FIG. 3. The speed controller 50 compares the speeds of the following vehicle 10 (see FIG. 7) and the lead vehicle 14 (see FIG. 7) and automatically adjusts the speed of the following vehicle 10 based upon the comparison. Adjustment may be made through the cruise control system 52 of the following vehicle 10 or by applying the brakes 54 of the following vehicle 10 for more rapid deceleration.

The speed controller 50 may contain certain criteria for evaluating differences in the speeds of the following vehicle 10 and the lead vehicle 14. For example, the speed controller 50 may be set to only adjust the speed of the following vehicle 10 if the difference is greater than some arbitrary quantity. Alternatively, the speed controller 50 may be simply set to increase the speed of the following vehicle 10 if the difference is positive and to decrease the speed of the following vehicle 10 if the difference is negative.

It will be understood that the foregoing description is of exemplary embodiments of this invention, and that the invention is not limited to the specific form shown. For example, the rear speed indicator may be mounted in a variety of locations on a vehicle such as on the rear bumper, on the trunk lid, on the rear windshield, or anywhere on the rear of the vehicle. The procedural steps discussed above for preventing traffic congestion may be altered depending on the amount of automation desired. For example, the response of the following vehicle may be manual or automated. These and other modifications in the design and arrangement of the elements may be made without departing from the scope of the invention as expressed in the dependent claims.

What is claimed is:

1. A system for improving traffic flow comprising warning automotive drivers of changes in speed and acceleration of a leading vehicle, comprising: an indicator mounted on the leading vehicle and configured to measure and display a speed and any change in acceleration of the leading vehicle for viewing outside of and behind the vehicle.

2. The system of claim 1, wherein the indicator comprises a GPS sensor mounted on the leading vehicle and configured to measure the speed and change of acceleration of the leading vehicle.

3. The system of claim 1, wherein the display comprises an alphanumeric display of the actual speed and wherein any change in acceleration of the first vehicle is represented by a change in the color of the display.

4. The system of claim 1, wherein the indicator further displays the speed and acceleration change for viewing by a driver of the leading vehicle through a rear view mirror of the leading vehicle.

5. The system of claim 1, wherein the indicator comprises a display projected on a rear windshield of the leading vehicle.

6. The system of claim 1, wherein the indicator is designed to be mounted on a rear windshield of the leading vehicle.

7. A warning system, comprising: a first vehicle having a GPS sensor mounted on the first vehicle and configured to sense a speed and any change in acceleration of the first vehicle; and a colored alphanumeric display mounted m the first vehicle, the alphanumeric display being coupled to a GPS sensor and configured to inform a second following vehicle of the first vehicle's speed and any change in acceleration of the first vehicle.

8. The warning system of claim 7, wherein the alphanumeric display is mounted on the trunk of the first vehicle.

9. The warning system of claim 7, wherein the alphanumeric display is configured to indicate the speed of the first vehicle in alphanumeric format to the second vehicle.

10. The warning system of claim 7, wherein the alphanumeric display is further configured to indicate the speed of the first vehicle to a driver of the first vehicle using an alphanumeric display mounted or projected on the rear windshield and readable by a driver of the first vehicle when viewed through a rear view mirror of the first vehicle.

11. The warning system of claim 7, wherein the alphanumeric display is configured to display the speed of the first vehicle when the speed is below a predetermined quantity.

12. The warning system of claim 7, wherein the alphanumeric display comprises a digital display.

13. The warning system of claim 7 whereby a change in acceleration of the first vehicle is represented by changing the display color from white for no change in velocity to green for a positive change in velocity to red for a negative change in velocity.

14. A method for communicating to a following driver of the speed and any change in the velocity of a lead vehicle, the method comprising a digital indicator display mounted on a lead vehicle wherein the display changes color from white for no change in velocity to green for a positive change in velocity to red for a negative change in velocity.

15. The method of claim 14, wherein the act of communicating a speed comprises displaying the speed numerically for viewing outside of and behind the vehicle.

16. The method of claim 14, wherein the act of communicating a speed further comprises displaying the speed numerically for viewing by a driver of the lead vehicle when the display is viewed through a rear view mirror of the lead vehicle.

17. The method of claim 14, wherein the act of communicating a speed and velocity change comprises activating the display only below a chosen speed for selective use in rush hour traffic conditions.

18. The method of claim 14, further comprising mounting the alphanumeric display on a rear portion of the vehicle.
